(19) United States
(12) Patent Application Publication
(10) Pub. No.: US 2025/0343737 A1
(43) Pub. Date: Nov. 6, 2025

(54) TECHNIQUES FOR PREDICTIVE LINK FAILURE REPORTING IN WIRELESS COMMUNICATIONS

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US); Mukesh Kumar MITTAL, San Diego, CA (US); Manish TRIPATHI, San Diego, CA (US)

(21) Appl. No.: 18/652,550

(22) Filed: May 1, 2024

(51) Int. Cl. H04L 41/147; H04L 41/16; H04L 41/5067; H04W 24/02

(52) U.S. Cl. CPC H04L 41/147; H04L 41/16; H04L 41/5067; H04W 24/02

(57) ABSTRACT

Methods, systems, and devices for wireless communications are described that provide for configuration of a user equipment (UE) to perform predictive radio failure identification, predictive estimation of Quality of Experience (QoE) degradation, predictive data rate estimation, or any combination thereof. The UE may report predictive radio failures and/or QoE degradation in advance of such an event. A network entity, based on the reported information, may proactively react to attempt to avoid radio failure, QoE degradation, or both, such as by changing one or more communications parameters with the UE. The UE may also indicate an estimated time or time deadline for the network to take action to prevent radio failure, QoE degradation, or both.

### FIELD OF TECHNOLOGY

The following relates to wireless communications, including techniques for predictive link failure reporting in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information for a radio link, where the configuration information enables UE prediction of radio link failure events that will impact a data rate, a spectrum efficiency, or a latency, for communications via the radio link, communicating with a network entity via the radio link, determining, based on the configuration information, that a predicted data rate, a predicted spectrum efficiency, or a predicted latency, for the communications via the radio link will be below a threshold data rate value, below a threshold spectrum efficiency value, or above a threshold latency value, at a future time instance, and transmitting an indication to the network entity that indicates the predicted data rate will be below the threshold data rate value, the predicted spectrum efficiency will be below the threshold spectrum efficiency value, or the predicted latency will be above the threshold latency value, and the future time instance.

A UE for wireless communications is described. The UE may include one or more memories storing processor executable code, and one or more processors coupled with the one or more memories. The one or more processors may individually or collectively be operable to execute the code to cause the UE to receive configuration information for a radio link, where the configuration information enables UE prediction of radio link failure events that will impact a data rate, a spectrum efficiency, or a latency, for communications via the radio link, communicate with a network entity via the radio link, determine, based on the configuration information, that a predicted data rate, a predicted spectrum efficiency, or a predicted latency, for the communications via the radio link will be below a threshold data rate value, below a threshold spectrum efficiency value, or above a threshold latency value, at a future time instance, and transmit an indication to the network entity that indicates the predicted data rate will be below the threshold data rate value, the predicted spectrum efficiency will be below the threshold spectrum efficiency value, or the predicted latency will be above the threshold latency value, and the future time instance.

Another UE for wireless communications is described. The UE may include means for receiving configuration information for a radio link, where the configuration information enables UE prediction of radio link failure events that will impact a data rate, a spectrum efficiency, or a latency, for communications via the radio link, means for communicating with a network entity via the radio link, means for determining, based on the configuration information, that a predicted data rate, a predicted spectrum efficiency, or a predicted latency, for the communications via the radio link will be below a threshold data rate value, below a threshold spectrum efficiency value, or above a threshold latency value, at a future time instance, and means for transmitting an indication to the network entity that indicates the predicted data rate will be below the threshold data rate value, the predicted spectrum efficiency will be below the threshold spectrum efficiency value, or the predicted latency will be above the threshold latency value, and the future time instance.

A non-transitory computer-readable medium storing code for wireless communications is described. The code may include instructions executable by one or more processors to receive configuration information for a radio link, where the configuration information enables UE prediction of radio link failure events that will impact a data rate, a spectrum efficiency, or a latency, for communications via the radio link, communicate with a network entity via the radio link, determine, based on the configuration information, that a predicted data rate, a predicted spectrum efficiency, or a predicted latency, for the communications via the radio link will be below a threshold data rate value, below a threshold spectrum efficiency value, or above a threshold latency value, at a future time instance, and transmit an indication to the network entity that indicates the predicted data rate will be below the threshold data rate value, the predicted spectrum efficiency will be below the threshold spectrum efficiency value, or the predicted latency will be above the threshold latency value, and the future time instance.

In some examples of the method, UEs, and non-transitory computer-readable medium described herein, transmitting the indication to the network entity may include operations, features, means, or instructions for transmitting a predicted radio link failure indication or an indication that a predicted quality of experience (QoE) associated with the communications will be below a QoE threshold associated with the threshold data rate value, the threshold spectrum efficiency value, or the threshold latency value.

Some examples of the method, UEs, and non-transitory computer-readable medium described herein may further include operations, features, means, or instructions for determining a first time associated with the predicted QoE, the predicted radio link failure, or a beam failure, and where the future time instance indicates the first time.

Some examples of the method, UEs, and non-transitory computer-readable medium described herein may further include operations, features, means, or instructions for receiving, from the network entity, an update to one or more communication parameters associated with the radio link, where the one or more communication parameters include one or more of a scheduling configuration, a multiple-input-multiple-output (MIMO) configuration, a mobility parameter, a bandwidth part (BWP) parameter, a carrier aggregation configuration, a dual-connectivity configuration, an uplink waveform, a beam switch and management configuration, a load balancing configuration or any combination thereof.

Some examples of the method, UEs, and non-transitory computer-readable medium described herein may further include operations, features, means, or instructions for transmitting a capability message that indicates a UE capability for one or more of predictive data rate, spectrum efficiency, latency, or quality of experience (QoE) determination.

In some examples of the method, UEs, and non-transitory computer-readable medium described herein, the determining may include operations, features, means, or instructions for determining that a difference between a first data rate at which data is being removed from a data buffer associated with the communications and a second data rate at which data is being added to the data buffer exceeds a threshold value.

Some examples of the method, UEs, and non-transitory computer-readable medium described herein may further include operations, features, means, or instructions for determining the future time instance associated with one or more of an empty buffer or quality of experience (QoE) degradation based on a quantity of data in the data buffer and the difference between the first data rate and the second data rate.

In some examples of the method, UEs, and non-transitory computer-readable medium described herein, the future time instance may be based on a timer associated with a radio link or beam failure or low spectrum efficiency detection.

In some examples of the method, UEs, and non-transitory computer-readable medium described herein, the indication may be provided in a medium access control (MAC) control element (CE) that provides a radio access network (RAN)-visible predicted quality of experience value.

In some examples of the method, UEs, and non-transitory computer-readable medium described herein, the determining may be based on an output of an artificial intelligence (AI) or machine-learning (ML) model at the UE.

In some examples of the method, UEs, and non-transitory computer-readable medium described herein, receiving the configuration information may include operations, features, means, or instructions for receiving, from the network entity, an AI or ML model configuration for prediction of radio-based quality-of-experience (QoE) degradation.

A method for wireless communications by a network entity is described. The method may include outputting configuration information to a UE for a radio link, where the configuration information enables UE prediction of radio link events that will impact a data rate, a spectrum efficiency, or a latency, for communications via the radio link, communicating with the UE via the radio link, and obtaining, from the UE, an indication associated with the radio link that indicates a predicted data rate at the UE will be below a threshold data rate value, a predicted spectrum efficiency will be below a threshold spectrum efficiency value, or a predicted latency at the UE will be above a threshold latency value, and a future time instance associated with the indication.

A network entity for wireless communications is described. The network entity may include one or more memories storing processor executable code, and one or more processors coupled with the one or more memories. The one or more processors may individually or collectively be operable to execute the code to cause the network entity to output configuration information to a UE for a radio link, where the configuration information enables UE prediction of radio link events that will impact a data rate, a spectrum efficiency, or a latency, for communications via the radio link, communicate with the UE via the radio link, and obtain, from the UE, an indication associated with the radio link that indicates a predicted data rate at the UE will be below a threshold data rate value, a predicted spectrum efficiency will be below a threshold spectrum efficiency value, or a predicted latency at the UE will be above a threshold latency value, and a future time instance associated with the indication.

Another network entity for wireless communications is described. The network entity may include means for outputting configuration information to a UE for a radio link, where the configuration information enables UE prediction of radio link events that will impact a data rate, a spectrum efficiency, or a latency, for communications via the radio link, means for communicating with the UE via the radio link, and means for obtaining, from the UE, an indication associated with the radio link that indicates a predicted data rate at the UE will be below a threshold data rate value, a predicted spectrum efficiency will be below a threshold spectrum efficiency value, or a predicted latency at the UE will be above a threshold latency value, and a future time instance associated with the indication.

A non-transitory computer-readable medium storing code for wireless communications is described. The code may include instructions executable by one or more processors to output configuration information to a UE for a radio link, where the configuration information enables UE prediction of radio link events that will impact a data rate, a spectrum efficiency, or a latency, for communications via the radio link, communicate with the UE via the radio link, and obtain, from the UE, an indication associated with the radio link that indicates a predicted data rate at the UE will be below a threshold data rate value, a predicted spectrum efficiency will be below a threshold spectrum efficiency value, or a predicted latency at the UE will be above a threshold latency value, and a future time instance associated with the indication.

In some examples of the method, network entities, and non-transitory computer-readable medium described herein, obtaining the indication may include operations, features, means, or instructions for obtaining a predicted radio link failure indication or an indication that a predicted quality of experience (QoE) associated with the communications will be below a QoE threshold associated with the threshold data rate, the threshold latency value, or the threshold latency value.

Some examples of the method, network entities, and non-transitory computer-readable medium described herein may further include operations, features, means, or instructions for determining a first time associated with the predicted QoE, the predicted radio link failure, or a beam failure, based on the future time instance associated with the indication.

Some examples of the method, network entities, and non-transitory computer-readable medium described herein may further include operations, features, means, or instructions for outputting an update to one or more communication parameters associated with the radio link, where the one or more communication parameters include one or more of a scheduling configuration, a multiple-input-multiple-output (MIMO) configuration, a mobility parameter, a bandwidth part (BWP) parameter, a carrier aggregation configuration, a dual-connectivity configuration, an uplink waveform, a beam switch and management configuration, or any combination thereof.

Some examples of the method, network entities, and non-transitory computer-readable medium described herein may further include operations, features, means, or instructions for obtaining, from the UE, a capability message that indicates a UE capability for one or more of predictive data rate, spectrum efficiency, latency, or quality of experience (QoE) determination.

In some examples of the method, network entities, and non-transitory computer-readable medium described herein, the future time instance may be based on a timer associated with a radio link or beam failure detection.

In some examples of the method, network entities, and non-transitory computer-readable medium described herein, the indication may be provided in a medium access control (MAC) control element (CE) that provides a radio access network (RAN)-visible predicted quality of experience value.

In some examples of the method, network entities, and non-transitory computer-readable medium described herein, the configuration information enables an artificial intelligence (AI) or machine-learning (ML) model at the UE that may be used to determine that the predicted data rate at the UE will be below the threshold data rate value, the predicted spectrum efficiency at the UE will be below the threshold spectrum efficiency value, the predicted latency at the UE will be above the threshold latency value, the future time instance, or any combination thereof.

In some examples of the method, network entities, and non-transitory computer-readable medium described herein, the configuration information provides an AI or ML model configuration for prediction of radio-based quality-of-experience (QoE) degradation.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for predictive link failure reporting in wireless communications in accordance with one or more aspects of the present disclosure.

FIG. 2 shows an example of a portion of a wireless communications system that supports techniques for predictive link failure reporting in wireless communications in accordance with one or more aspects of the present disclosure.

FIG. 3 shows an example of a data stream playback related quality in accordance with one or more aspects of the present disclosure.

FIG. 4 shows an example of a process flow that supports techniques for predictive link failure reporting in wireless communications in accordance with one or more aspects of the present disclosure.

FIGS. 5 and 6 show block diagrams of devices that support techniques for predictive link failure reporting in wireless communications in accordance with one or more aspects of the present disclosure.

FIG. 7 shows a block diagram of a communications manager that supports techniques for predictive link failure reporting in wireless communications in accordance with one or more aspects of the present disclosure.

FIG. 8 shows a diagram of a system including a device that supports techniques for predictive link failure reporting in wireless communications in accordance with one or more aspects of the present disclosure.

FIGS. 9 and 10 show block diagrams of devices that support techniques for predictive link failure reporting in wireless communications in accordance with one or more aspects of the present disclosure.

FIG. 11 shows a block diagram of a communications manager that supports techniques for predictive link failure reporting in wireless communications in accordance with one or more aspects of the present disclosure.

FIG. 12 shows a diagram of a system including a device that supports techniques for predictive link failure reporting in wireless communications in accordance with one or more aspects of the present disclosure.

FIGS. 13 through 16 show flowcharts illustrating methods that support techniques for predictive link failure reporting in wireless communications in accordance with one or more aspects of the present disclosure.

### DETAILED DESCRIPTION

Many users of wireless communications devices may stream data from a network for playback on the wireless communications device, which may be referred to as a user equipment (UE). In such cases, the network may transmit data at a sufficient data rate to support playback at the UE that meets one or more quality metric targets, which may depend on the type of data that is provided via the streaming session. A user experience of the playback (e.g., playback of a video and/or audio stream) may be degraded if the playback rate exceeds the rate at which the associated data is received at the UE, which may result in drop-outs of the playback while the UE performs rebuffing of data, and/or may result in reduced quality (e.g., lower video and/or audio resolution). In some systems, a serving network (e.g., a serving radio access network (RAN)) may provide a mechanism for a UE to report quality information associated with streamed data. For example, RAN-visible quality of experience (QoE) data may provide data associated with an application (e.g., an audio or video streaming app, a virtual reality (VR) or augmented reality (AR) app, etc.). after usage of the application is completed. For example, a video stream application may have QoE metrics associated with a video playback recorded, and the QoE metrics may be reported to the network at some point after the video playback is complete. For example, if a radio link failure (RLF) occurs, the UE may record RLF location, time, and cause in a UE buffer, and then report RLF back to the network at a later time. The network may use this data to adjust future scheduling parameters for future instances of such an application, which may allow for future improvements for future users. However, such QoE metric reporting does not provide a mechanism for a UE to report that QoE metrics of an ongoing data stream are likely to not meet QoE targets. Techniques that could provide such metrics may be useful to enhance user experience and provide more reliable data flows.

In accordance with various aspects discussed herein, a UE may be configured to perform predictive radio failure identification, predictive estimation of QoE degradation, predictive data rate estimation, or any combination thereof. In some aspects, a UE may report a UE capability to perform such predictive computations, and may be configured by the network to run an algorithm to generate predicted QoE values or radio link failure events (e.g., an artificial intelligence (AI) or machine learning (ML) algorithm). In some cases, the UE may report predictive radio failures and/or QoE degradation in advance, prior to an associated data buffer of an application or a data stream becoming empty. The network, based on the reported information, may proactively react to attempt to avoid QoE degradation, such as by changing one or more scheduling parameters, initiating UE mobility among network entities (e.g., a handover of the UE between serving network entities), initiating a change in a bandwidth part (BWP) used for communications with the UE, changing one or more carrier aggregation (CA) or dual-connectivity (DC) parameters, changing load balancing parameters, changing a waveform for communications, or any combination thereof. Further, in some aspects, the network may also use the QoE degradation information to prevent QoE degradations in the future if no actions were taken based on the predictive metrics indicated by the UE. In some aspects, the UE may provide the report in a medium access control (MAC) control element (CE) that indicates QoE degradation (e.g., a prediction of one or more radio link events that may impact a data rate or a latency for communications via a radio link) with possible RAN-related issues, and an estimated time or time deadline for the network to take action to prevent QoE degradation (e.g., to avoid video freezing/rebuffering).

In some aspects, one or more AI/ML models to predict QoE degradation (e.g., video steam pause or resolution reduction during playing) or radio failures (e.g., call drop, data stall, etc.) in advance, and report such a prediction to the network in advance, which may allow the network to act in advance of, and potentially avoid, such a QoE degradation or radio failure. Further, in some aspects, a UE may report an estimated tine associated with the QoE degradation or radio failure, which may provide a timeline for the network to take action to avoid such an event. Such techniques may provide for enhanced network efficiency through reduced failures and retransmissions, and provide for enhanced user experience through fewer degradations in QoE for playback of streamed data.

Aspects of the disclosure are initially described in the context of wireless communications systems. Aspects of the disclosure are further illustrated by and described with reference to playback parameters for a data stream, a process flow, apparatus diagrams, system diagrams, and flowcharts that relate to techniques for predictive link failure reporting in wireless communications.

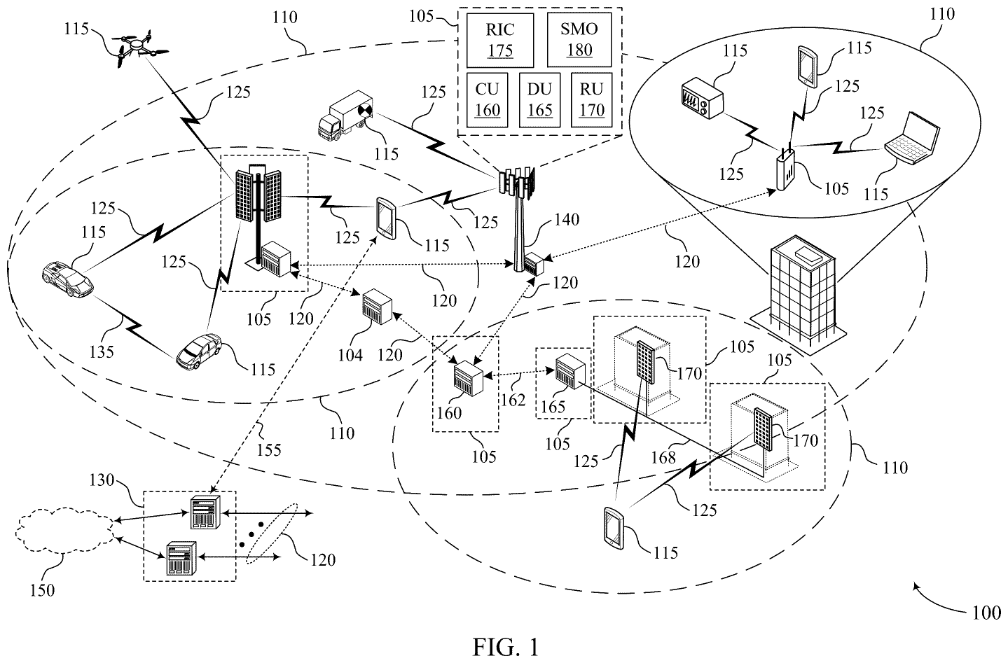

FIG. 1 shows an example of a wireless communications system 100 that supports techniques for predictive link failure reporting in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some aspects, a UE 115 may be configured to perform predictive radio failure identification, predictive estimation of QoE degradation, predictive data rate estimation, predictive spectrum efficiency estimation, predictive latency estimation, or any combination thereof. In some aspects, the UE 115 may provide a capability indication for a capability to perform such predictive computations, and may be configured by a network entity 105 to run an algorithm to generate predicted QoE values or radio link failure events (e.g., an AI/ML algorithm). In some cases, the UE 115 may report predictive radio failures and/or QoE degradation in advance, prior to an associated data buffer of an application or a data stream becoming empty. The network entity 105, based on the reported information, may proactively react to attempt to avoid QoE degradation, such as by changing one or more scheduling parameters, initiating UE 115 mobility among network entities 105 (e.g., a handover of the UE between serving network entities), initiating a change in a BWP used for communications with the UE 115, changing one or more CA or DC parameters, changing load balancing parameters, changing a waveform for communications, or any combination thereof. Further, in some aspects, the network entity 105 may also use the QoE degradation information to prevent QoE degradations in the future if no actions were taken based on the predictive metrics indicated by the UE 115. In some aspects, the UE 115 may provide the report in a MAC-CE that indicates QoE degradation with possible RAN-related issues, and an estimated time or time deadline for the network to take action to prevent QoE degradation.

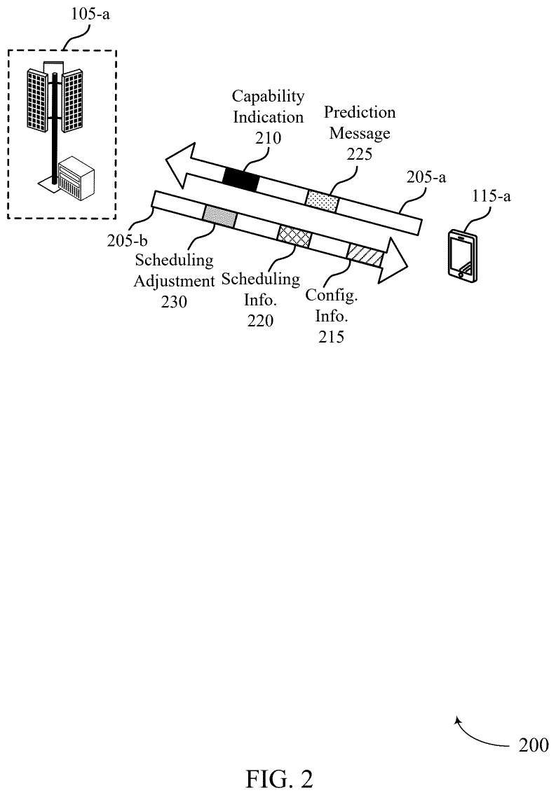

FIG. 2 shows an example of a wireless communications system 200 that supports techniques for predictive link failure reporting in wireless communications in accordance with one or more aspects of the present disclosure. In some examples, aspects of the wireless communications system 200 may implement, or be implemented by, aspects of the wireless communications system 100. In particular, the wireless communications system 200 illustrates signaling and configurations for predictive link failure reporting, as described herein.

The wireless communications system 200 may include a UE 115-a and a network entity 105-a, which may be examples of wireless devices as described herein. In some aspects, the UE 115-a and the network entity 105-a may communicate with one another using a communication link 205, which may be an example of an NR or LTE link, a sidelink (e.g., PC5 link), and the like, between the respective devices. In some cases, the communication link 205 may include an example of an access link (e.g., Uu link) which may include a bi-directional link that enables both uplink and downlink communication. For example, the UE 115-a may transmit uplink signals, such as uplink control signals or uplink data signals, to one or more components of the network entity 105-a using the communication link 205-a, and one or more components of the network entity 105-a may transmit downlink signals, such as downlink control signals or downlink data signals, to the UE 115-a using the communication link 205-b.

In some aspects, the UE 115-a may transmit a capability indication 210 to the network entity 105-a, which may indicate a capability of the UE 115-a to perform predictions for QoE metrics, data rates, spectrum efficiency, latency, radio failures, and the like. For example, the UE 115-a may indicate a capability to predict one or more QoE degradation or radio failure events based on one or more parameters associated with an ongoing data communication stream (e.g., data rate changes, channel measurements, block error rate estimations, channel state information (CSI) measurements, or any combination thereof). Additionally, in some aspects, the capability indication 210 may indicate one or more AI/ML models that are configured at the UE 115-a for performing predictions of for QoE metrics, data rates, spectral efficiency, latency, radio failures, and the like.

In some aspects, the network entity 105-a may transmit configuration information 215 that indicates that the UE 115-a is to perform predictions for QoE metrics, data rates, spectrum efficiency, data latency, radio failures, or any combination thereof. For example, the configuration information 215 may enable predictive determinations, and indicate one or more AI/ML models at the UE 115-a associated with a data stream or application at the UE 115-a. The configuration information 215 may be provided, for example, in one or more system information (SI) transmissions of the network entity 105-a, in radio resource control (RRC) configuration signaling, in downlink control information (DCI), in one or more MAC-CEs, or any combination thereof. The network entity 105-a may transmit scheduling information 220 for initial communications of a data stream, and may initiate communications for the data stream.

In accordance with various aspects, the UE 115-b may perform predictive determinations of QoE metrics, data rates, spectrum efficiency, data latency, radio failures, or any combination thereof, and may send a prediction message 225 to the network entity 105-a that indicates a potential issue with the data stream communications. In some cases, the prediction message 225 may also indicate a time at which a potential failure or QoE degradation is predicted to occur. In some cases, the prediction message 225 may be provided in a MAC-CE that is transmitted to the network entity 105-a. In some aspects, based on information in the prediction message 225, the network entity 105-a may modify one or more communications parameters associated with the data stream, and transmit scheduling adjustment 230 to the UE 115-a, which may avoid the predicted failure or QoE degradation.

In some cases, the prediction message 225 may be provided as part of, or in addition to, signaling of RAN-visible QoE metrics. For example, RAN-visible QoE metrics may include one or more of a buffer level and playout delay for media startup. In some cases, a set of available RAN-visible QoE metrics may be a subset of metrics which are configured as part of a QoE measurement configuration, and the network entity 105-a may configure RAN-visible QoE measurement to collect all or some of the available RAN-visible QoE metrics, where the indication of metric availability may be received from a core network (CN) or an operations and management (OAM) entity associated with the network entity 105-a. For example, RAN-visible QoE metrics may be provided in a class-2 message (e.g., over F1 application protocol (F1AP)) provided for QoE information transfer to transfer RAN-visible QoE information (e.g., from a CU to a DU associated with the network entity 105-a). In some aspects, the UE 115-a and network entity 105-a may support various service types, such as augmented reality (AR), mixed reality (MR), multicast broadcast services (MBS) or other service types defined or to be supported. In some examples, the network entity 105-a may specify QoE measurement configuration and collection in RRC_INACTIVE and RRC_IDLE states for MBS service, at least for broadcast service. Additionally, or alternatively, in some cases QoE measurement configuration may be provided for one or more network slices, and may provide for reporting of one or more measured or predicted QoE values based on a trigger event (e.g., QoE degradation that exceeds a threshold value).

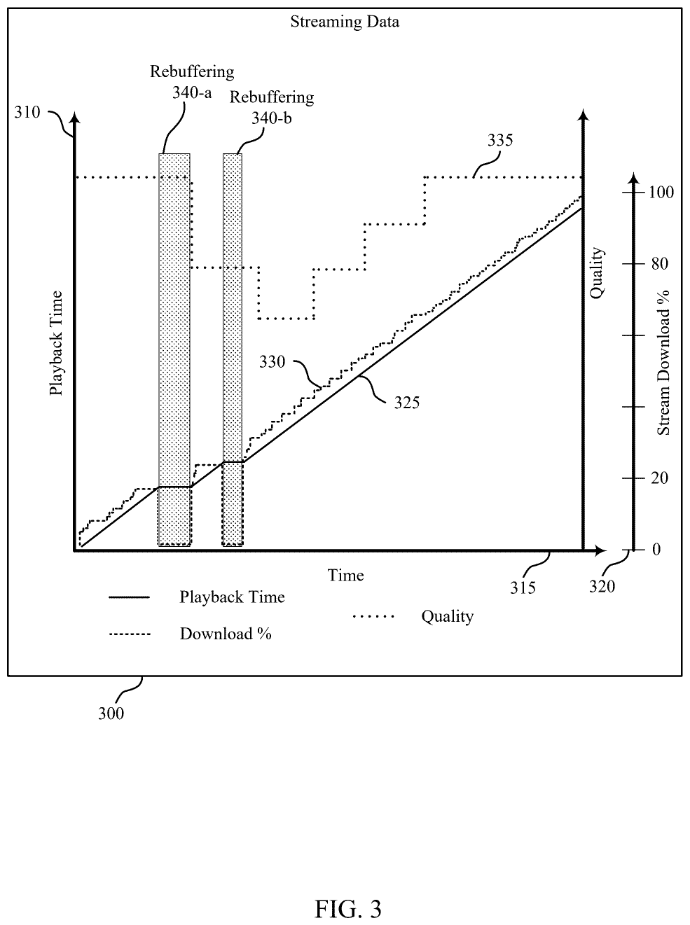

As discussed herein, the prediction message 225 may be provided during an ongoing data stream, in addition to or alternatively to QoE data that is reported after communications of the data stream is completed. The network entity 105-a, in some cases, may proactively react to attempt to avoid QoE degradation or radio failure, such as by changing one or more scheduling parameters, initiating UE 115-a mobility among network entities 105 (e.g., a handover of the UE 115-a between serving network entities 105), initiating a change in a BWP used for communications with the UE 115-a, changing one or more CA or DC parameters, changing load balancing parameters, changing a waveform for communications, or any combination thereof. Further, in some aspects, the network entity 105-a may also use the QoE degradation information to prevent QoE degradations in the future if no actions were taken based on the predictive metrics indicated by the UE 115-a. In some aspects, the UE 115 may provide an estimated time or time deadline for the network to take action to prevent QoE degradation (e.g., the estimated time may initiate a timer start (such as a T310 timer start), and RLF will occur after the timer expires). In some cases, a differential in a data buffer input and output may be used as an input to an AI/ML model at the UE 115-a to predict a QoE degradation or radio failure. For example, a download video speed may be less than a video playing speed, and an associated video buffer may be emptied, or video resolution reduced, at a time that is identified based on the differential between the speeds. FIG. 3 illustrates an example, of a data stream playback in which a predictive QoE degradation or radio failure may be identified.

FIG. 3 shows an example of a data stream playback related quality 300 that supports techniques for predictive link failure reporting in wireless communications in accordance with one or more aspects of the present disclosure. In some examples, aspects of the data stream playback related quality 300 may implement, or be implemented by, aspects of the wireless communications systems 100 or 200. In particular, the data stream playback related quality 300 illustrates various aspects of a data stream playback in which a device that receives the data stream (e.g., a UE) may perform prediction for QoE degradation or radio failure, as described herein.

In this example, a playback time 310 may correspond to a time associated with a playback of a data stream (e.g., a video playback having a 30 second duration), and a UE time 315 may correspond to a time at which an associated portion of the data stream is played at the UE. A stream download percent 320 is also illustrated, which downlink percent 330 relative to playback time 325 illustrated in FIG. 3. In this example, two instances of rebuffering 340 may occur (e.g., due to radio failures) that result in a playback quality 335 (e.g., QoE) being reduced for some periods. In the example, of FIG. 3, a first instance of rebuffering 340-a may occur when a quality 335 associated with the data stream is relatively high (e.g., a 4K resolution of a video stream), which may cause playback to freeze at the UE and diminish the quality 335. A second instance of rebuffering 340-b may further reduce the quality 335 of the data stream (e.g., to a 720p resolution of the video stream). In this example, data rates may be sustained for the remainder of the playback that allow the quality 335 to return to a high quality (e.g., 4K resolution of the video stream). In accordance with various aspects discussed herein, a UE may predictively determine that a QoE degradation or radio failure (e.g., associated with rebuffering 340) is likely to occur.

Predictive indications of such events may allow the serving network entity to take actions to prevent QoE degradation. In some cases, RAN features that may impact QoE may include, for example, quality of service (QoS) class identifier (QCI), 5G QoS identifier (5QI), carrier aggregation (CA), mobility handover margin (HOM), MIMO, BWP bandwidth, among others. In some cases, network features that may impact QoE may include, for example, pre-scheduling operations, scheduling request (SR) periodicity, MIMO implementation, uplink waveform switching, and/or handover, among others. In some cases, device (e.g., UE) features that may impact QoE may include, for example, a UE power class, supported CA band combinations, non-stand-alone (NSA) or stand-alone (SA) configuration, and UE-based fast return from a network fallback, among others. In some cases, network architecture features that may impact QoE may include, for example, SA/NSA configuration, network slicing, presence of edge nodes, cell density, RF coverage, and cell optimization, among others. In some aspects, based on a predictive QoE degradation or radio failure indication by a UE, one or more network entities may modify one or more of such RAN features, network features, or network architecture features, to help avoid an indicated QoE degradation (e.g., reduced data rate or increased latency that may result in QoE degradation) or radio failure.

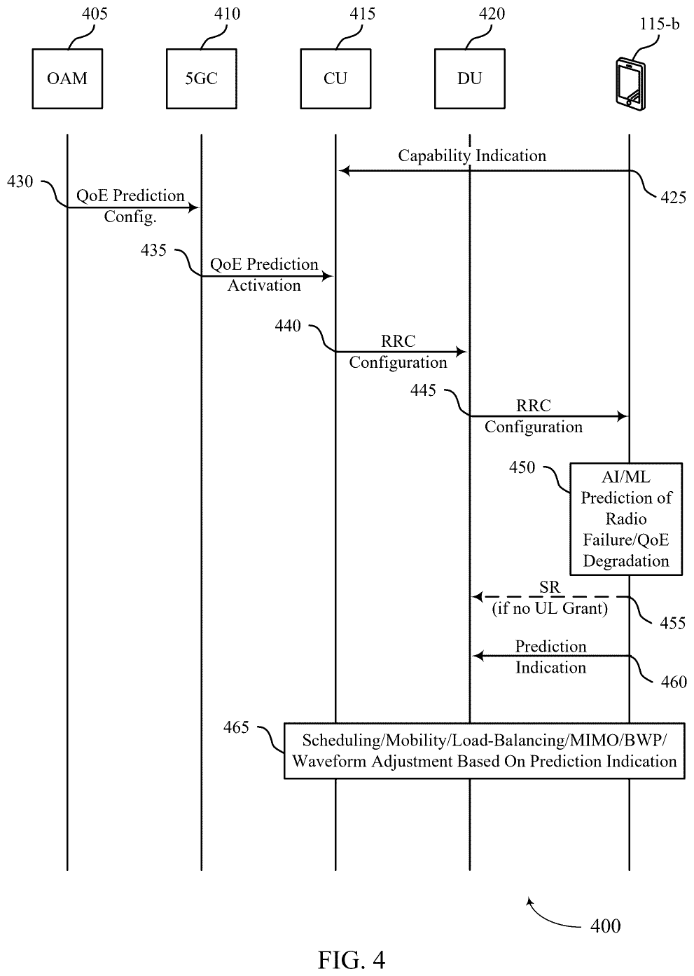

FIG. 4 shows an example of a process flow 400 that supports techniques for predictive link failure reporting in wireless communications in accordance with one or more aspects of the present disclosure. In some examples, aspects of the process flow 400 may implement, or be implemented by, aspects of the wireless communications system 100. In particular, the process flow 400 illustrates various implementations for predictive QoE degradation or radio failure in which a device may report a predicted QoE degradation or radio failure, which may be acted upon by the network to help avoid such an event, as described herein.

The process flow 400 includes a UE 115-b and multiple network entities, including an OAM entity 405, a core network 410 (e.g., 5G core network 5GC), a CU 415, and a DU 420, which may be examples of wireless devices as described herein. In this regard, the UE 115-b may be an example of a UE 115 that is capable of predicting one or more QoE degradation or radio failure events associated with a data stream.

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 425, the UE 115-b may transmit a capability indication, which may be received at CU 415 (e.g., via DU 420). As discussed herein, the capability indication may provide a UE 115-b capability for performing predictive QoE or radio failure events associated with a data stream. In some cases, the capability indication may also indicate a UE 115-b processing capability or capability for one or more types of AI/ML models. In some aspects, the capability indication may be provided as part of RRC signaling between the UE 115-b and the network.

At 430, the OAM entity 405 may transmit, and the core network 410 may receive, a QoE prediction configuration that may be provided to UE 115-b. At 435, the core network 410 may provide QoE prediction configuration and activation information to CU 415. At 440, the CU may provide RRC configuration information for transmission to the UE 115-b, and at 445 the DU 420 may transmit, and the UE 115-b may receive, RRC configuration information with QoE prediction configuration. In some cases, the QoE prediction configuration may identify one or more model-IDs associated with one or more data streams or types of data (e.g., associated with different network slices). In some aspects, the UE 115-b may be preloaded with one or more candidate models associated with different model IDs; and the UE may select the appropriate model for prediction tasks based on the configuration information. For example, a first AI/ML model whose input includes channel measurement parameters and different input/output buffer data rates may be used for prediction at the UE 115-b for video streaming, and a second AI/ML model whose input includes channel measurement parameters and different input/output buffer data rates may be used for prediction at the UE 115-b for a VR or MR stream.

At 450, the UE 115-b may perform AI/ML prediction of radio failure and/or QoE degradation. As discussed herein, such AI/ML prediction may be based on an AI/ML model and one or more inputs, such as channel conditions and data rates. In some aspects, an AI/ML model at the UE 115-b may use a learning model management procedure that may be implemented by the UE 115-b or components (e.g., one or more memories storing processor-executable code, one or more processors coupled with the one or more memories and individually or collectively operable to execute the code to cause the UE 115-b to perform the operations) as described herein. For example, during a configuration or reconfiguration phase, the UE 115-b may receive a set of one or more configurations including a set of one or more parameters for configuring or reconfiguring one or more AI/ML models (e.g., artificial intelligence models, machine learning models). The UE 115-b may receive a request message for configuring or reconfiguring the one or more AI/ML models. The request may include the set of one or more configurations and one or more identifiers associated with one or more AI/ML models. In some examples, the set of one or more parameters may be for managing (e.g., training, updating, modifying) the one or more AI/ML models. In some other examples, the set of one or more parameters may be an input for the one or more AI/ML models, for example, for inference of the one or more AI/ML models. In other examples, the set of one or more parameters may be for monitoring one or more performance metrics (also referred to as KPIs) for the one or more AI/ML models. Additionally, or alternatively, the set of one or more configurations may include one or more RRC configurations (e.g., one or more measurement configurations, one or more MAC configurations, or the like).

During an activation phase, the UE 115-b may activate at least one AI/ML model (e.g., for at least one action). During a training phase, the UE 115-d may train the at least one AI/ML model to obtain a set of one or more outputs based at least in part on a set of one or more inputs (e.g., a set of one or more parameters). During a deactivation phase, the UE 115-b may deactivate the at least one AI/ML model (e.g., for at least one action). During a monitoring phase, the UE 115-b may monitor (e.g., track) a performance of the at least one AI/ML model. One or more of a network entity, or the UE 115-b may share (e.g., transmit, receive, exchange) feedback associated with the performance of the at least one model. The performance may be associated with a system performance or a model performance (e.g., prediction accuracy, resource usage, inference delay, etc.). In some examples, a switching event may be triggered to switch (e.g., change) from at least one AI/ML model to at least one different AI/ML model, for example, based at least in part on a type of data associated with a data stream, data rates associated with the data stream, or any combination thereof. In some examples, one or more of a network entity, or the UE 115-b, may update the training of the at least one AI/ML model based at least in part on the feedback associated with the performance of the at least one AI/ML model.

At 460, the UE 115-b, if a QoE degradation or radio failure is predicted, may transmit a prediction indication. In some cases, the UE 115-b may transmit a SR at 455, in the event that an uplink grant is not present, to trigger an uplink grant that may be used to transmit the prediction indication. At 465, the UE 115-b, CU 415, and DU 420 may perform one or more adjustments to scheduling, mobility, load balancing, MIMO, BWP, CA, DC, waveform selection, or any combination thereof, based on the prediction indication.

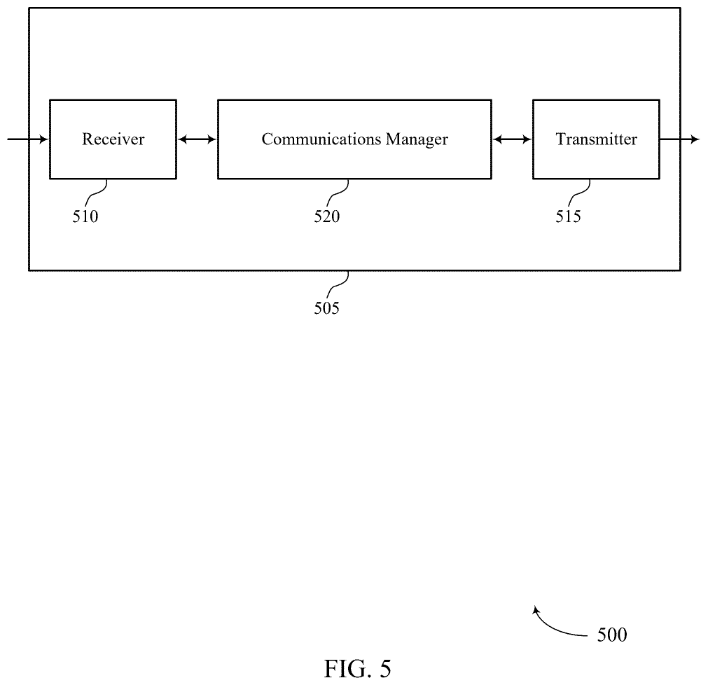

FIG. 5 shows a block diagram 500 of a device 505 that supports techniques for predictive link failure reporting in wireless communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for predictive link failure reporting in wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for predictive link failure reporting in wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for predictive link failure reporting in wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving configuration information for a radio link, where the configuration information enables UE prediction of radio link failure events that will impact a data rate, or a latency, for communications via the radio link. The communications manager 520 is capable of, configured to, or operable to support a means for communicating with a network entity via the radio link. The communications manager 520 is capable of, configured to, or operable to support a means for determining, based on the configuration information, that a predicted data rate, a predicted spectrum efficiency, or a predicted latency, for the communications via the radio link will be below a threshold data rate value, below a threshold spectrum efficiency value, or above a threshold latency value, at a future time instance. The communications manager 520 is capable of, configured to, or operable to support a means for transmitting an indication to the network entity that indicates the predicted data rate will be below the threshold data rate value, below a threshold spectrum efficiency value, or the predicted latency will be above the threshold latency value, and the future time instance.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for prediction of QoE degradation or radio failures based on one or more AI/ML models in advance of an actual QoE degradation or radio failure, and report such a prediction to the network. Such techniques may allow the network to act in advance of, and potentially avoid, such a QoE degradation or radio failure, which may provide for enhanced network efficiency, and enhanced user experience.

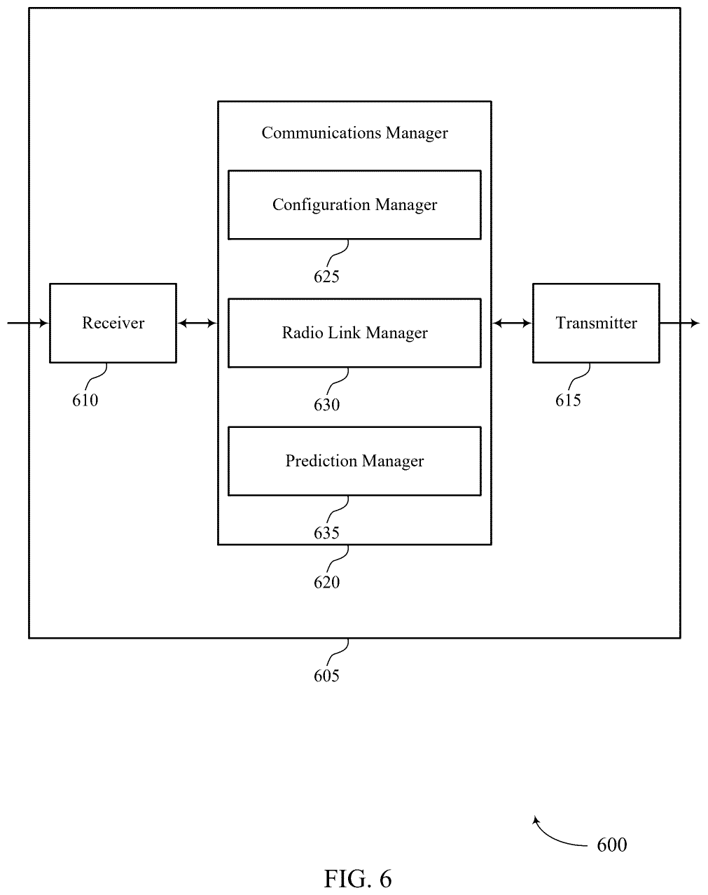

FIG. 6 shows a block diagram 600 of a device 605 that supports techniques for predictive link failure reporting in wireless communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for predictive link failure reporting in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for predictive link failure reporting in wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for predictive link failure reporting in wireless communications as described herein. For example, the communications manager 620 may include a configuration manager 625, a radio link manager 630, a prediction manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration manager 625 is capable of, configured to, or operable to support a means for receiving configuration information for a radio link, where the configuration information enables UE prediction of radio link failure events that will impact a data rate, or a latency, for communications via the radio link. The radio link manager 630 is capable of, configured to, or operable to support a means for communicating with a network entity via the radio link. The prediction manager 635 is capable of, configured to, or operable to support a means for determining, based on the configuration information, that a predicted data rate, a predicted spectrum efficiency value, or a predicted latency, for the communications via the radio link will be below a threshold data rate value, below a threshold spectrum efficiency value, or above a threshold latency value, at a future time instance. The prediction manager 635 is capable of, configured to, or operable to support a means for transmitting an indication to the network entity that indicates the predicted data rate will be below the threshold data rate value, below the threshold spectrum efficiency value, or the predicted latency will be above the threshold latency value, and the future time instance.

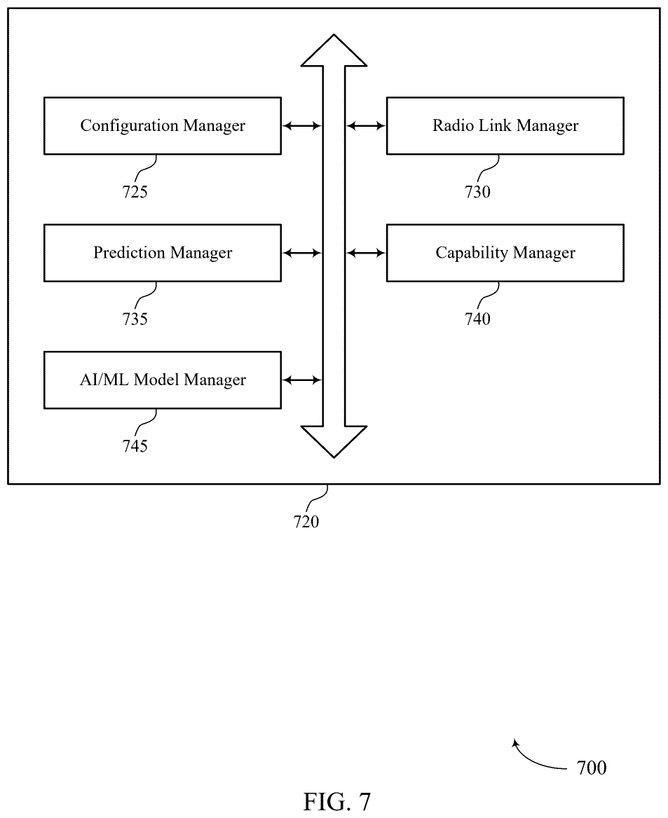

FIG. 7 shows a block diagram 700 of a communications manager 720 that supports techniques for predictive link failure reporting in wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for predictive link failure reporting in wireless communications as described herein. For example, the communications manager 720 may include a configuration manager 725, a radio link manager 730, a prediction manager 735, a capability manager 740, an AI/ML model manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration manager 725 is capable of, configured to, or operable to support a means for receiving configuration information for a radio link, where the configuration information enables UE prediction of radio link failure events that will impact a data rate, or a latency, for communications via the radio link. The radio link manager 730 is capable of, configured to, or operable to support a means for communicating with a network entity via the radio link. The prediction manager 735 is capable of, configured to, or operable to support a means for determining, based on the configuration information, that a predicted data rate, a predicted spectrum efficiency value, or a predicted latency, for the communications via the radio link will be below a threshold data rate value, below a threshold spectrum efficiency value, or above a threshold latency value, at a future time instance. In some examples, the prediction manager 735 is capable of, configured to, or operable to support a means for transmitting an indication to the network entity that indicates the predicted data rate will be below the threshold data rate value, below the threshold spectrum efficiency value, or the predicted latency will be above the threshold latency value, and the future time instance.

In some examples, to support transmitting the indication to the network entity, the prediction manager 735 is capable of, configured to, or operable to support a means for transmitting a predicted radio link failure indication or an indication that a predicted quality of experience (QoE) associated with the communications will be below a QoE threshold associated with the threshold data rate, or the threshold latency value. In some examples, the prediction manager 735 is capable of, configured to, or operable to support a means for determining a first time associated with the predicted QoE, the predicted radio link failure, or a beam failure, and where the future time instance indicates the first time.

In some examples, the radio link manager 730 is capable of, configured to, or operable to support a means for receiving, from the network entity, an update to one or more communication parameters associated with the radio link, where the one or more communication parameters include one or more of a scheduling configuration, a multiple-input-multiple-output (MIMO) configuration, a mobility parameter, a bandwidth part (BWP) parameter, a carrier aggregation configuration, a dual-connectivity configuration, an uplink waveform, a beam switch and management configuration, or any combination thereof.

In some examples, the capability manager 740 is capable of, configured to, or operable to support a means for transmitting a capability message that indicates a UE capability for one or more of predictive data rate, spectrum efficiency, latency, or quality of experience (QoE) determination.

In some examples, to support determining, the prediction manager 735 is capable of, configured to, or operable to support a means for determining that a difference between a first data rate at which data is being removed from a data buffer associated with the communications and a second data rate at which data is being added to the data buffer exceeds a threshold value.

In some examples, the prediction manager 735 is capable of, configured to, or operable to support a means for determining the future time instance associated with one or more of an empty buffer or quality of experience (QoE) degradation based on a quantity of data in the data buffer and the difference between the first data rate and the second data rate. In some examples, the future time instance is based on a timer associated with a radio link or beam failure detection. In some examples, the indication is provided in a MAC-CE that provides a RAN-visible predicted quality of experience value. In some examples, the determining is based on an output of an AI or ML model at the UE. In some examples, to support receiving the configuration information, the AI/ML model manager 745 is capable of, configured to, or operable to support a means for receiving, from the network entity, an AI or ML model configuration for prediction of radio-based QoE degradation.

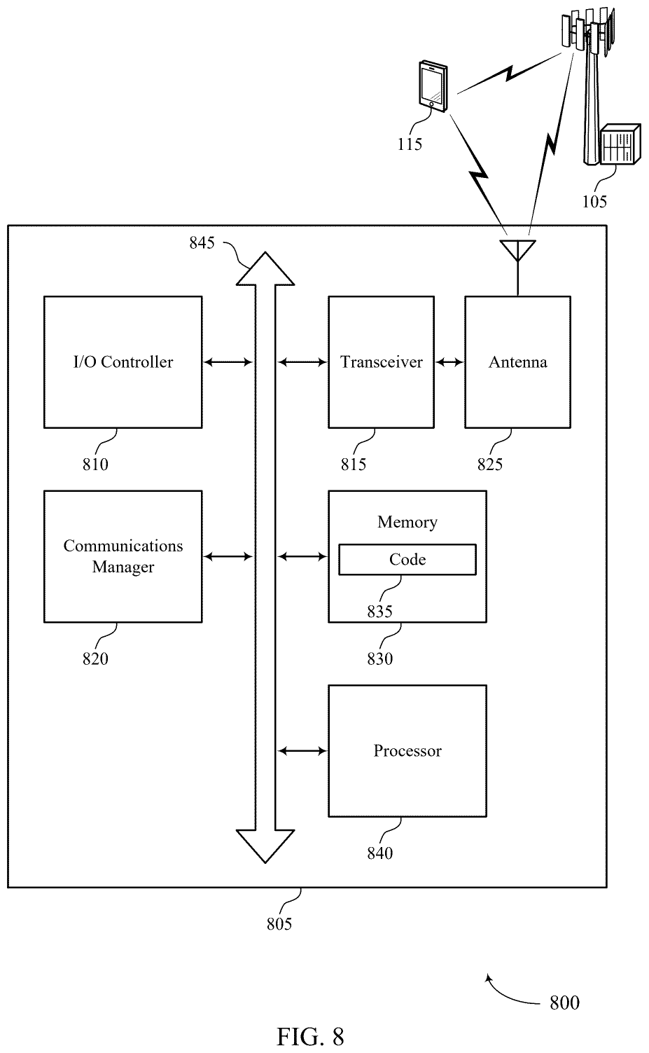

FIG. 8 shows a diagram of a system 800 including a device 805 that supports techniques for predictive link failure reporting in wireless communications in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for predictive link failure reporting in wireless communications). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving configuration information for a radio link, where the configuration information enables UE prediction of radio link failure events that will impact a data rate, or a latency, for communications via the radio link. The communications manager 820 is capable of, configured to, or operable to support a means for communicating with a network entity via the radio link. The communications manager 820 is capable of, configured to, or operable to support a means for determining, based on the configuration information, that a predicted data rate, a predicted spectrum efficiency value, or a predicted latency, for the communications via the radio link will be below a threshold data rate value, below a threshold spectrum efficiency value, or above a threshold latency value, at a future time instance. The communications manager 820 is capable of, configured to, or operable to support a means for transmitting an indication to the network entity that indicates the predicted data rate will be below the threshold data rate value, below the threshold spectrum efficiency value, or the predicted latency will be above the threshold latency value, and the future time instance.

By including or configuring the communications manager 820 in accordance with examples as described herein, the device 805 may support techniques for prediction of QoE degradation or radio failures based on one or more AI/ML models in advance of an actual QoE degradation or radio failure, and report such a prediction to the network. Such techniques may allow the network to act in advance of, and potentially avoid, such a QoE degradation or radio failure, which may provide for enhanced network efficiency, and enhanced user experience.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for predictive link failure reporting in wireless communications as described herein, or the at least one processor 840 and the at least one memory 830 may be otherwise configured to, individually or collectively, perform or support such operations.

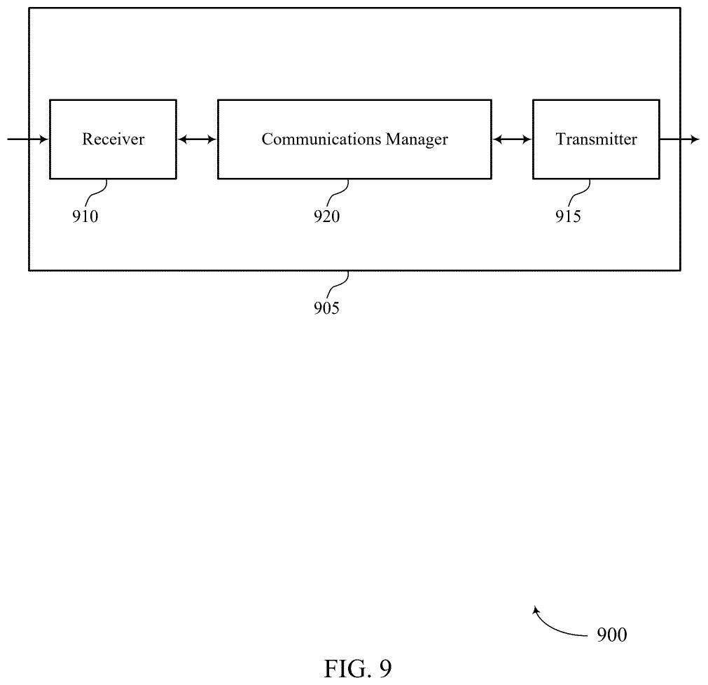

FIG. 9 shows a block diagram 900 of a device 905 that supports techniques for predictive link failure reporting in wireless communications in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for predictive link failure reporting in wireless communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting configuration information to a UE for a radio link, where the configuration information enables UE prediction of radio link failure events that will impact a data rate, or a latency, for communications via the radio link. The communications manager 920 is capable of, configured to, or operable to support a means for communicating with the UE via the radio link. The communications manager 920 is capable of, configured to, or operable to support a means for obtaining, from the UE, an indication associated with the radio link that indicates a predicted data rate at the UE will be below a threshold data rate value, below a threshold spectrum efficiency value, or a predicted latency at the UE will be above a threshold latency value, and a future time instance associated with the indication.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for prediction of QoE degradation or radio failures based on one or more AI/ML models in advance of an actual QoE degradation or radio failure, and report such a prediction to the network. Such techniques may allow the network to act in advance of, and potentially avoid, such a QoE degradation or radio failure, which may provide for enhanced network efficiency, and enhanced user experience.

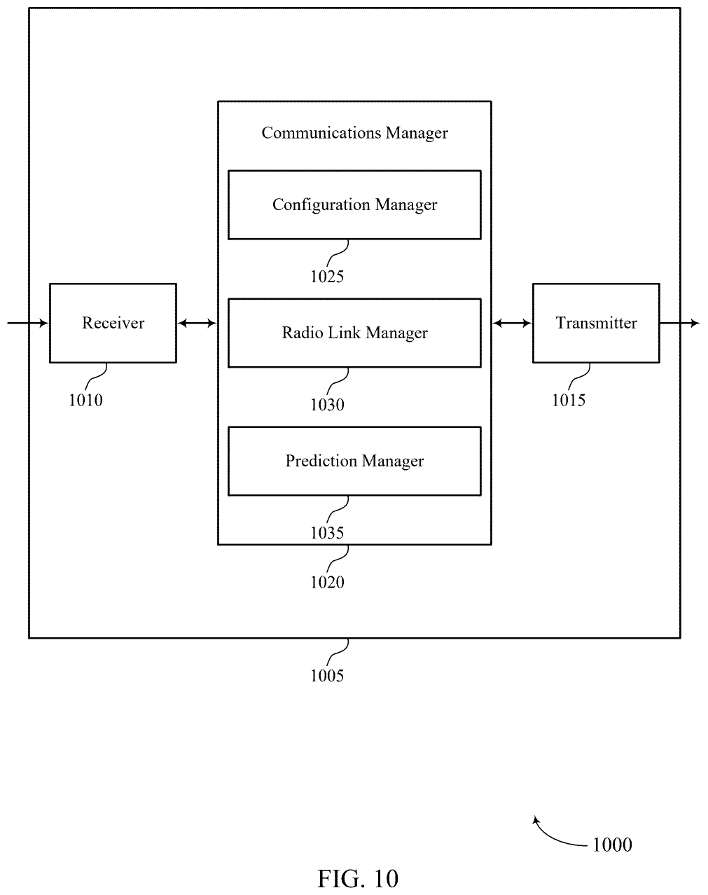

FIG. 10 shows a block diagram 1000 of a device 1005 that supports techniques for predictive link failure reporting in wireless communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for predictive link failure reporting in wireless communications as described herein. For example, the communications manager 1020 may include a configuration manager 1025, a radio link manager 1030, a prediction manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration manager 1025 is capable of, configured to, or operable to support a means for outputting configuration information to a UE for a radio link, where the configuration information enables UE prediction of radio link failure events that will impact a data rate, or a latency, for communications via the radio link. The radio link manager 1030 is capable of, configured to, or operable to support a means for communicating with the UE via the radio link. The prediction manager 1035 is capable of, configured to, or operable to support a means for obtaining, from the UE, an indication associated with the radio link that indicates a predicted data rate, a predicted spectrum efficiency at the UE will be below a threshold data rate value or below a threshold spectrum efficiency value, or a predicted latency at the UE will be above a threshold latency value, and a future time instance associated with the indication.

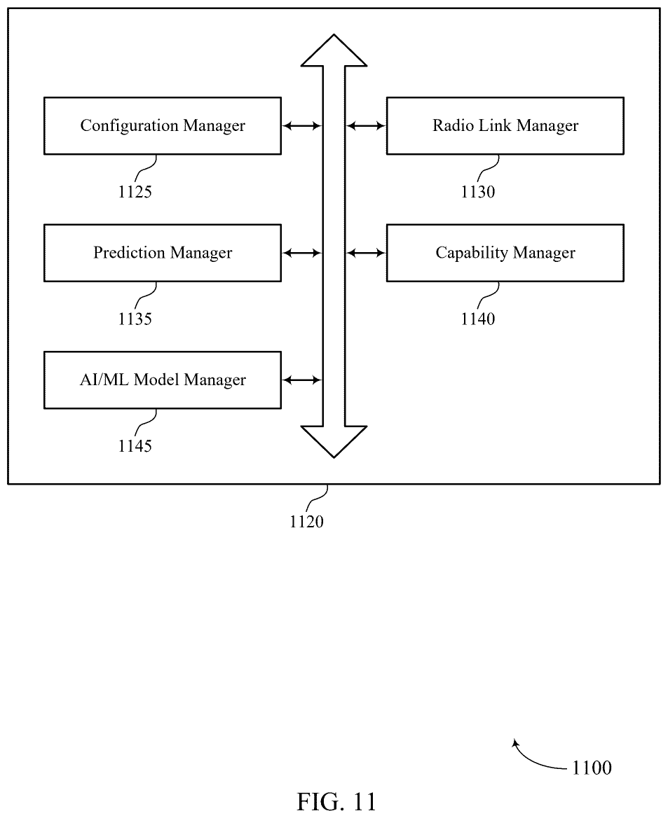

FIG. 11 shows a block diagram 1100 of a communications manager 1120 that supports techniques for predictive link failure reporting in wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for predictive link failure reporting in wireless communications as described herein. For example, the communications manager 1120 may include a configuration manager 1125, a radio link manager 1130, a prediction manager 1135, a capability manager 1140, an AI/ML model manager 1145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration manager 1125 is capable of, configured to, or operable to support a means for outputting configuration information to a UE for a radio link, where the configuration information enables UE prediction of radio link failure events that will impact a data rate, or a latency, for communications via the radio link. The radio link manager 1130 is capable of, configured to, or operable to support a means for communicating with the UE via the radio link. The prediction manager 1135 is capable of, configured to, or operable to support a means for obtaining, from the UE, an indication associated with the radio link that indicates a predicted data rate at the UE will be below a threshold data rate value, a predicted spectrum efficiency will be below a threshold spectrum efficiency value, or a predicted latency at the UE will be above a threshold latency value, and a future time instance associated with the indication.

In some examples, to support obtaining the indication, the prediction manager 1135 is capable of, configured to, or operable to support a means for obtaining a predicted radio link failure indication or an indication that a predicted quality of experience (QoE) associated with the communications will be below a QoE threshold associated with the threshold data rate, or the threshold latency value. In some examples, the prediction manager 1135 is capable of, configured to, or operable to support a means for determining a first time associated with the predicted QoE, the predicted radio link failure, or a beam failure, based on the future time instance associated with the indication.

In some examples, the radio link manager 1130 is capable of, configured to, or operable to support a means for outputting an update to one or more communication parameters associated with the radio link, where the one or more communication parameters include one or more of a scheduling configuration, a multiple-input-multiple-output (MIMO) configuration, a mobility parameter, a bandwidth part (BWP) parameter, a carrier aggregation configuration, a dual-connectivity configuration, an uplink waveform, a beam switch and management configuration, or any combination thereof.

In some examples, the capability manager 1140 is capable of, configured to, or operable to support a means for obtaining, from the UE, a capability message that indicates a UE capability for one or more of predictive data rate, spectrum efficiency, latency, or quality of experience (QoE) determination. In some examples, the future time instance is based on a timer associated with a radio link or beam failure detection. In some examples, the indication is provided in a MAC-CE that provides a RAN-visible predicted quality of experience value. In some examples, the configuration information enables an AI or ML model at the UE that is used to determine that the predicted data rate at the UE will be below the threshold data rate value, the predicted latency at the UE will be above the threshold latency value, the future time instance, or any combination thereof. In some examples, the configuration information provides an AI or ML model configuration for prediction of radio-based QoE degradation.

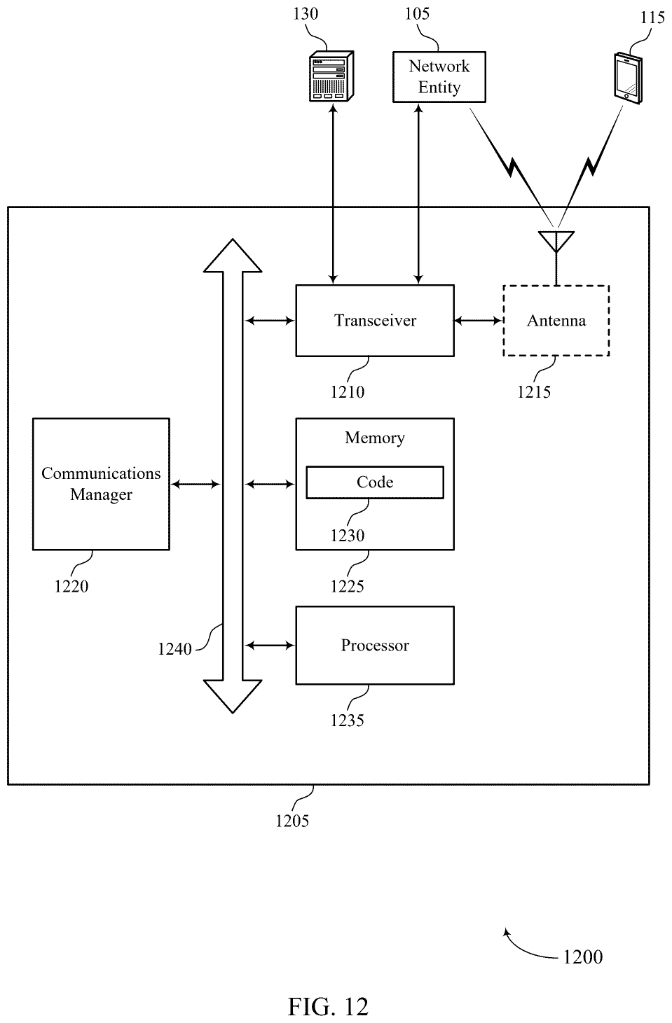

FIG. 12 shows a diagram of a system 1200 including a device 1205 that supports techniques for predictive link failure reporting in wireless communications in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for predictive link failure reporting in wireless communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting configuration information to a UE for a radio link, where the configuration information enables UE prediction of radio link failure events that will impact a data rate, or a latency, for communications via the radio link. The communications manager 1220 is capable of, configured to, or operable to support a means for communicating with the UE via the radio link. The communications manager 1220 is capable of, configured to, or operable to support a means for obtaining, from the UE, an indication associated with the radio link that indicates a predicted data rate at the UE will be below a threshold data rate value, a predicted spectrum efficiency will be below a threshold spectrum efficiency value, or a predicted latency at the UE will be above a threshold latency value, and a future time instance associated with the indication.

By including or configuring the communications manager 1220 in accordance with examples as described herein, the device 1205 may support techniques for prediction of QoE degradation or radio failures based on one or more AI/ML models in advance of an actual QoE degradation or radio failure, and report such a prediction to the network. Such techniques may allow the network to act in advance of, and potentially avoid, such a QoE degradation or radio failure, which may provide for enhanced network efficiency, and enhanced user experience.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for predictive link failure reporting in wireless communications as described herein, or the at least one processor 1235 and the at least one memory 1225 may be otherwise configured to, individually or collectively, perform or support such operations.

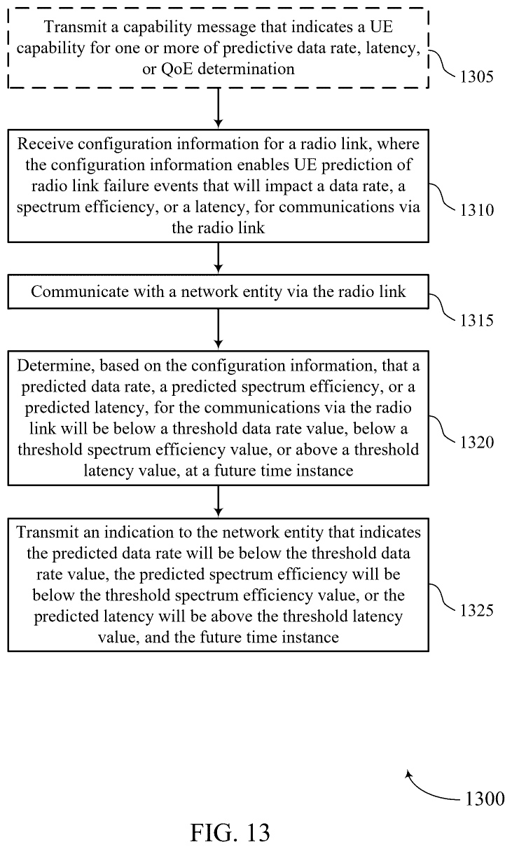

FIG. 13 shows a flowchart illustrating a method 1300 that supports techniques for predictive link failure reporting in wireless communications in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

Optionally, at 1305, the method may include transmitting a capability message that indicates a UE capability for one or more of predictive data rate, spectrum efficiency, latency, or quality of experience (QoE) determination. The operations of 1305 may be performed in accordance with examples as disclosed herein. In some examples, aspects of the operations of 1305 may be performed by a capability manager 740 as described with reference to FIG. 7.

At 1310, the method may include receiving configuration information for a radio link, where the configuration information enables UE prediction of radio link failure events that will impact a data rate, or a latency, for communications via the radio link. The operations of 1310 may be performed in accordance with examples as disclosed herein. In some examples, aspects of the operations of 1310 may be performed by a configuration manager 725 as described with reference to FIG. 7.

At 1315, the method may include communicating with a network entity via the radio link. The operations of 1315 may be performed in accordance with examples as disclosed herein. In some examples, aspects of the operations of 1315 may be performed by a radio link manager 730 as described with reference to FIG. 7.

At 1320, the method may include determining, based on the configuration information, that a predicted data rate, a predicted spectrum efficiency, or a predicted latency, for the communications via the radio link will be below a threshold data rate value, below a threshold spectrum efficiency value, or above a threshold latency value, at a future time instance. The operations of 1320 may be performed in accordance with examples as disclosed herein. In some examples, aspects of the operations of 1320 may be performed by a prediction manager 735 as described with reference to FIG. 7.

At 1325, the method may include transmitting an indication to the network entity that indicates the predicted data rate will be below the threshold data rate value, the predicted spectrum efficiency will be below a threshold spectrum efficiency value, or the predicted latency will be above the threshold latency value, and the future time instance. The operations of 1325 may be performed in accordance with examples as disclosed herein. In some examples, aspects of the operations of 1325 may be performed by a prediction manager 735 as described with reference to FIG. 7.

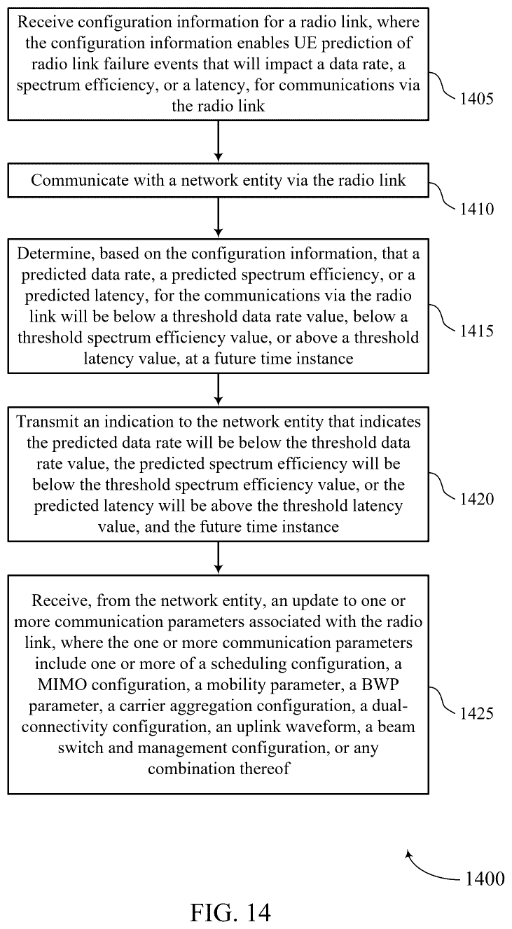

FIG. 14 shows a flowchart illustrating a method 1400 that supports techniques for predictive link failure reporting in wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving configuration information for a radio link, where the configuration information enables UE prediction of radio link failure events that will impact a data rate, or a latency, for communications via the radio link. The operations of 1405 may be performed in accordance with examples as disclosed herein. In some examples, aspects of the operations of 1405 may be performed by a configuration manager 725 as described with reference to FIG. 7.

At 1410, the method may include communicating with a network entity via the radio link. The operations of 1410 may be performed in accordance with examples as disclosed herein. In some examples, aspects of the operations of 1410 may be performed by a radio link manager 730 as described with reference to FIG. 7.

At 1415, the method may include determining, based on the configuration information, that a predicted data rate, a predicted spectrum efficiency, or a predicted latency, for the communications via the radio link will be below a threshold data rate value, below a threshold spectrum efficiency value, or above a threshold latency value, at a future time instance. The operations of 1415 may be performed in accordance with examples as disclosed herein. In some examples, aspects of the operations of 1415 may be performed by a prediction manager 735 as described with reference to FIG. 7.

At 1420, the method may include transmitting an indication to the network entity that indicates the predicted data rate will be below the threshold data rate value, the predicted spectrum efficiency value will be below the threshold spectrum efficiency value, or the predicted latency will be above the threshold latency value, and the future time instance. The operations of 1420 may be performed in accordance with examples as disclosed herein. In some examples, aspects of the operations of 1420 may be performed by a prediction manager 735 as described with reference to FIG. 7.

At 1425, the method may include receiving, from the network entity, an update to one or more communication parameters associated with the radio link, where the one or more communication parameters include one or more of a scheduling configuration, a multiple-input-multiple-output (MIMO) configuration, a mobility parameter, a bandwidth part (BWP) parameter, a carrier aggregation configuration, a dual-connectivity configuration, an uplink waveform, a beam switch and management configuration, or any combination thereof. The operations of 1425 may be performed in accordance with examples as disclosed herein. In some examples, aspects of the operations of 1425 may be performed by a radio link manager 730 as described with reference to FIG. 7.

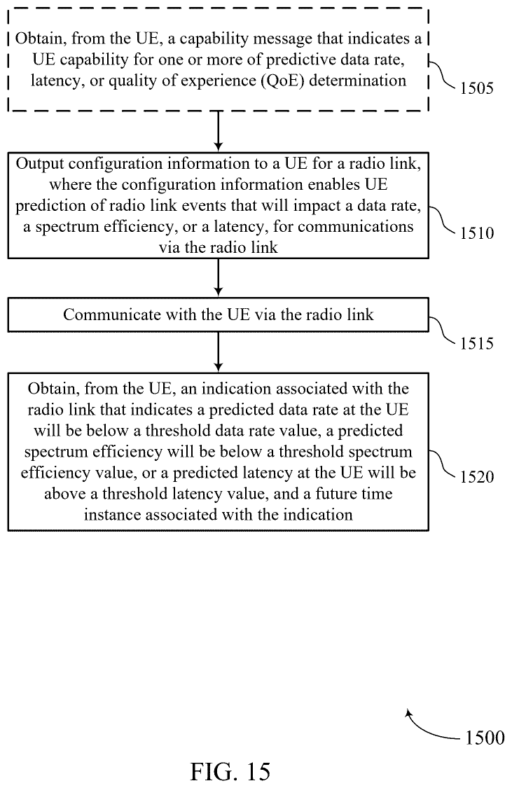

FIG. 15 shows a flowchart illustrating a method 1500 that supports techniques for predictive link failure reporting in wireless communications in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

Optionally, at 1505, the method may include obtaining, from the UE, a capability message that indicates a UE capability for one or more of predictive data rate, spectrum efficiency, latency, or quality of experience (QoE) determination. The operations of 1505 may be performed in accordance with examples as disclosed herein. In some examples, aspects of the operations of 1505 may be performed by a capability manager 1140 as described with reference to FIG. 11.

At 1510, the method may include outputting configuration information to a UE for a radio link, where the configuration information enables UE prediction of radio link failure events that will impact a data rate, or a latency, for communications via the radio link. The operations of 1510 may be performed in accordance with examples as disclosed herein. In some examples, aspects of the operations of 1510 may be performed by a configuration manager 1125 as described with reference to FIG. 11.

At 1515, the method may include communicating with the UE via the radio link. The operations of 1515 may be performed in accordance with examples as disclosed herein. In some examples, aspects of the operations of 1515 may be performed by a radio link manager 1130 as described with reference to FIG. 11.

At 1520, the method may include obtaining, from the UE, an indication associated with the radio link that indicates a predicted data rate at the UE will be below a threshold data rate value, a predicted spectrum efficiency will be below a threshold spectrum efficiency value, or a predicted latency at the UE will be above a threshold latency value, and a future time instance associated with the indication. The operations of 1520 may be performed in accordance with examples as disclosed herein. In some examples, aspects of the operations of 1520 may be performed by a prediction manager 1135 as described with reference to FIG. 11.

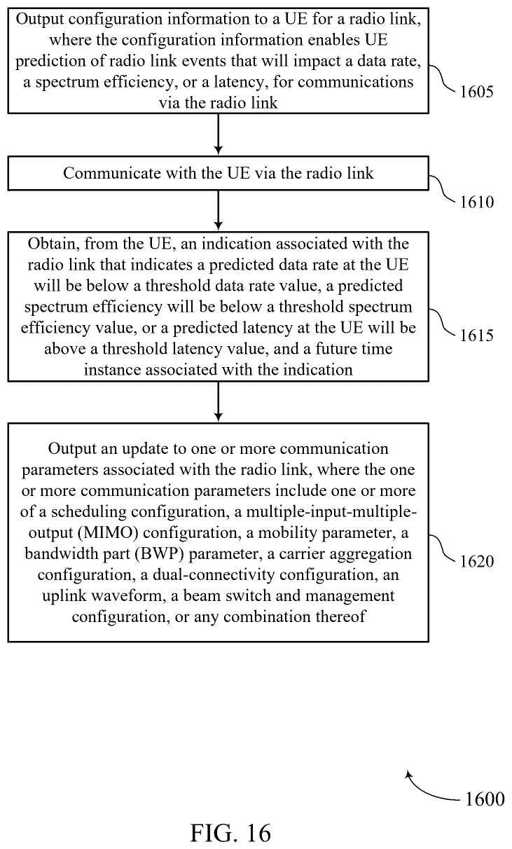

FIG. 16 shows a flowchart illustrating a method 1600 that supports techniques for predictive link failure reporting in wireless communications in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting configuration information to a UE for a radio link, where the configuration information enables UE prediction of radio link failure events that will impact a data rate, or a latency, for communications via the radio link. The operations of 1605 may be performed in accordance with examples as disclosed herein. In some examples, aspects of the operations of 1605 may be performed by a configuration manager 1125 as described with reference to FIG. 11.

At 1610, the method may include communicating with the UE via the radio link. The operations of 1610 may be performed in accordance with examples as disclosed herein. In some examples, aspects of the operations of 1610 may be performed by a radio link manager 1130 as described with reference to FIG. 11.

At 1615, the method may include obtaining, from the UE, an indication associated with the radio link that indicates a predicted data rate at the UE will be below a threshold data rate value, a predicted spectrum efficiency will be below a threshold spectrum efficiency value, or a predicted latency at the UE will be above a threshold latency value, and a future time instance associated with the indication. The operations of 1615 may be performed in accordance with examples as disclosed herein. In some examples, aspects of the operations of 1615 may be performed by a prediction manager 1135 as described with reference to FIG. 11.

At 1620, the method may include outputting an update to one or more communication parameters associated with the radio link, where the one or more communication parameters include one or more of a scheduling configuration, a multiple-input-multiple-output (MIMO) configuration, a mobility parameter, a bandwidth part (BWP) parameter, a carrier aggregation configuration, a dual-connectivity configuration, an uplink waveform, a beam switch and management configuration, or any combination thereof. The operations of 1620 may be performed in accordance with examples as disclosed herein. In some examples, aspects of the operations of 1620 may be performed by a radio link manager 1130 as described with reference to FIG. 11.

The following provides an overview of aspects of the present disclosure:

Aspect 1: A method for wireless communications at a UE, comprising: receiving configuration information for a radio link, wherein the configuration information enables UE prediction of radio link failure events that will impact a data rate, a spectrum efficiency, or a latency, for communications via the radio link; communicating with a network entity via the radio link; determining, based at least in part on the configuration information, that a predicted data rate, a predicted spectrum efficiency, or a predicted latency, for the communications via the radio link will be below a threshold data rate value, below a threshold spectrum efficiency value, or above a threshold latency value, at a future time instance; and transmitting an indication to the network entity that indicates the predicted data rate will be below the threshold data rate value, the predicted spectrum efficiency will be below the threshold spectrum efficiency value, or the predicted latency will be above the threshold latency value, and the future time instance.

Aspect 2: The method of aspect 1, wherein transmitting the indication to the network entity further comprises: transmitting a predicted radio link failure indication or an indication that a predicted quality of experience (QoE) associated with the communications will be below a QoE threshold associated with the threshold data rate value, the threshold spectrum efficiency value, or the threshold latency value.

Aspect 3: The method of aspect 2, further comprising: determining a first time associated with the predicted QoE, the predicted radio link failure, or a beam failure, and wherein the future time instance indicates the first time.

Aspect 4: The method of any of aspects 1 through 3, further comprising: receiving, from the network entity, an update to one or more communication parameters associated with the radio link, wherein the one or more communication parameters comprise one or more of a scheduling configuration, a multiple-input-multiple-output (MIMO) configuration, a mobility parameter, a bandwidth part (BWP) parameter, a carrier aggregation configuration, a dual-connectivity configuration, an uplink waveform, a beam switch and management configuration, a load balancing configuration or any combination thereof.

Aspect 5: The method of any of aspects 1 through 4, further comprising: transmitting a capability message that indicates a UE capability for one or more of predictive data rate, spectrum efficiency, latency, or quality of experience (QoE) determination.

Aspect 6: The method of any of aspects 1 through 5, wherein the determining comprises: determining that a difference between a first data rate at which data is being removed from a data buffer associated with the communications and a second data rate at which data is being added to the data buffer exceeds a threshold value.

Aspect 7: The method of aspect 6, further comprising: determining the future time instance associated with one or more of an empty buffer or quality of experience (QoE) degradation based at least in part on a quantity of data in the data buffer and the difference between the first data rate and the second data rate.

Aspect 8: The method of any of aspects 1 through 7, wherein the future time instance is based at least in part on a timer associated with a radio link or beam failure or low spectrum efficiency detection.

Aspect 9: The method of any of aspects 1 through 8, wherein the indication is provided in a medium access control (MAC) control element (CE) that provides a radio access network (RAN)-visible predicted quality of experience value.

Aspect 10: The method of any of aspects 1 through 9, wherein the determining is based at least in part on an output of an artificial intelligence (AI) or machine-learning (ML) model at the UE.

Aspect 11: The method of aspect 10, wherein receiving the configuration information comprises: receiving, from the network entity, an AI or ML model configuration for prediction of radio-based quality-of-experience (QoE) degradation.

Aspect 12: A method for wireless communications at a network entity, comprising: outputting configuration information to a UE for a radio link, wherein the configuration information enables UE prediction of radio link events that will impact a data rate, a spectrum efficiency, or a latency, for communications via the radio link; communicating with the UE via the radio link; and obtaining, from the UE, an indication associated with the radio link that indicates a predicted data rate at the UE will be below a threshold data rate value, a predicted spectrum efficiency will be below a threshold spectrum efficiency value, or a predicted latency at the UE will be above a threshold latency value, and a future time instance associated with the indication.

Aspect 13: The method of aspect 12, wherein obtaining the indication further comprises: obtaining a predicted radio link failure indication or an indication that a predicted quality of experience (QoE) associated with the communications will be below a QoE threshold associated with the threshold data rate, the threshold latency value, or the threshold latency value.

Aspect 14: The method of aspect 13, further comprising: determining a first time associated with the predicted QoE, the predicted radio link failure, or a beam failure, based at least in part on the future time instance associated with the indication.

Aspect 15: The method of any of aspects 12 through 14, further comprising: outputting an update to one or more communication parameters associated with the radio link, wherein the one or more communication parameters comprise one or more of a scheduling configuration, a multiple-input-multiple-output (MIMO) configuration, a mobility parameter, a bandwidth part (BWP) parameter, a carrier aggregation configuration, a dual-connectivity configuration, an uplink waveform, a beam switch and management configuration, or any combination thereof.

Aspect 16: The method of any of aspects 12 through 15, further comprising: obtaining, from the UE, a capability message that indicates a UE capability for one or more of predictive data rate, spectrum efficiency, latency, or quality of experience (QoE) determination.

Aspect 17: The method of any of aspects 12 through 16, wherein the future time instance is based at least in part on a timer associated with a radio link or beam failure detection.

Aspect 18: The method of any of aspects 12 through 17, wherein the indication is provided in a medium access control (MAC) control element (CE) that provides a radio access network (RAN)-visible predicted quality of experience value.

Aspect 19: The method of any of aspects 12 through 18, wherein the configuration information enables an artificial intelligence (AI) or machine-learning (ML) model at the UE that is used to determine that the predicted data rate at the UE will be below the threshold data rate value, the predicted spectrum efficiency at the UE will be below the threshold spectrum efficiency value, the predicted latency at the UE will be above the threshold latency value, the future time instance, or any combination thereof.

Aspect 20: The method of aspect 19, wherein the configuration information provides an AI or ML model configuration for prediction of radio-based quality-of-experience (QoE) degradation.

Aspect 21: A UE for wireless communications, comprising one or more memories storing processor-executable code, and one or more processors coupled with the one or more memories and individually or collectively operable to execute the code to cause the UE to perform a method of any of aspects 1 through 11.

Aspect 22: A UE for wireless communications, comprising at least one means for performing a method of any of aspects 1 through 11.

Aspect 23: A non-transitory computer-readable medium storing code for wireless communications, the code comprising instructions executable by one or more processors to perform a method of any of aspects 1 through 11.

Aspect 24: A network entity for wireless communications, comprising one or more memories storing processor-executable code, and one or more processors coupled with the one or more memories and individually or collectively operable to execute the code to cause the network entity to perform a method of any of aspects 12 through 20.

Aspect 25: A network entity for wireless communications, comprising at least one means for performing a method of any of aspects 12 through 20.

Aspect 26: A non-transitory computer-readable medium storing code for wireless communications, the code comprising instructions executable by one or more processors to perform a method of any of aspects 12 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information for a radio link, wherein the configuration information enables UE prediction of radio link failure events that will impact a data rate, a spectrum efficiency, or a latency, for communications via the radio link;
communicate with a network entity via the radio link;
determine, based at least in part on the configuration information, that a predicted data rate, a predicted spectrum efficiency, or a predicted latency, for the communications via the radio link will be below a threshold data rate value, below a threshold spectrum efficiency value, or above a threshold latency value, at a future time instance; and
transmit an indication to the network entity that indicates the predicted data rate will be below the threshold data rate value, the predicted spectrum efficiency will be below the threshold spectrum efficiency value, or the predicted latency will be above the threshold latency value, and the future time instance.

2. The UE of claim 1, wherein, to transmit the indication to the network entity, the one or more processors are individually or collectively further operable to execute the code to cause the UE to:
transmit a predicted radio link failure indication or an indication that a predicted quality of experience (QoE) associated with the communications will be below a QoE threshold associated with the threshold data rate value, the threshold spectrum efficiency value, or the threshold latency value.

3. The UE of claim 2, wherein the one or more processors are individually or collectively further operable to execute the code to cause the UE to:
determine a first time associated with the predicted QoE, the predicted radio link failure, or a beam failure, and wherein the future time instance indicates the first time.

4. The UE of claim 1, wherein the one or more processors are individually or collectively further operable to execute the code to cause the UE to:
receive, from the network entity, an update to one or more communication parameters associated with the radio link, wherein the one or more communication parameters comprise one or more of a scheduling configuration, a multiple-input-multiple-output (MIMO) configuration, a mobility parameter, a bandwidth part (BWP) parameter, a carrier aggregation configuration, a dual-connectivity configuration, an uplink waveform, a beam switch and management configuration, a load balancing configuration or any combination thereof.

5. The UE of claim 1, wherein the one or more processors are individually or collectively further operable to execute the code to cause the UE to:
transmit a capability message that indicates a UE capability for one or more of predictive data rate, spectrum efficiency, latency, or quality of experience (QoE) determination.

6. The UE of claim 1, wherein, to determine, the one or more processors are individually or collectively operable to execute the code to cause the UE to:
determine that a difference between a first data rate at which data is being removed from a data buffer associated with the communications and a second data rate at which data is being added to the data buffer exceeds a threshold value.

7. The UE of claim 6, wherein the one or more processors are individually or collectively further operable to execute the code to cause the UE to:
determine the future time instance associated with one or more of an empty buffer or quality of experience (QoE) degradation based at least in part on a quantity of data in the data buffer and the difference between the first data rate and the second data rate.

8. The UE of claim 1, wherein the future time instance is based at least in part on a timer associated with a radio link or beam failure or low spectrum efficiency detection.

9. The UE of claim 1, wherein the predicted indication is provided in a medium access control (MAC) control element (CE) that provides a radio access network (RAN)-visible predicted quality of experience value.

10. The UE of claim 1, wherein the determining is based at least in part on an output of an artificial intelligence (AI) or machine-learning (ML) model at the UE.

11. The UE of claim 10, wherein, to receive the configuration information, the one or more processors are individually or collectively operable to execute the code to cause the UE to:
receive, from the network entity, an AI or ML model configuration for prediction of radio-based quality-of-experience (QoE) degradation.

12. A method for wireless communications at a user equipment (UE), comprising:
receiving configuration information for a radio link, wherein the configuration information enables UE prediction of radio link failure events that will impact a data rate, a spectrum efficiency, or a latency, for communications via the radio link;
communicating with a network entity via the radio link;
determining, based at least in part on the configuration information, that a predicted data rate, a predicted spectrum efficiency, or a predicted latency, for the communications via the radio link will be below a threshold data rate value, below a threshold spectrum efficiency value, or above a threshold latency value, at a future time instance; and
transmitting an indication to the network entity that indicates the predicted data rate will be below the threshold data rate value, the predicted spectrum efficiency will be below the threshold spectrum efficiency value, or the predicted latency will be above the threshold latency value, and the future time instance.

13. The method of claim 12, wherein transmitting the indication to the network entity further comprises:
transmitting a predicted radio link failure indication or an indication that a predicted quality of experience (QoE) associated with the communications will be below a QoE threshold associated with the threshold data rate value, the threshold spectrum efficiency value, or the threshold latency value.

14. The method of claim 13, further comprising:
determining a first time associated with the predicted QoE, the predicted radio link failure, or a beam failure, and wherein the future time instance indicates the first time.

15. The method of claim 12, further comprising:
receiving, from the network entity, an update to one or more communication parameters associated with the radio link, wherein the one or more communication parameters comprise one or more of a scheduling configuration, a multiple-input-multiple-output (MIMO) configuration, a mobility parameter, a bandwidth part (BWP) parameter, a carrier aggregation configuration, a dual-connectivity configuration, an uplink waveform, a beam switch and management configuration, load balancing configuration, or any combination thereof.

16. The method of claim 12, further comprising:
transmitting a capability message that indicates a UE capability for one or more of predictive data rate, spectrum efficiency, latency, or quality of experience (QoE) determination.

17. The method of claim 12, wherein the determining comprises:
determining that a difference between a first data rate at which data is being removed from a data buffer associated with the communications and a second data rate at which data is being added to the data buffer exceeds a threshold value.

18. The method of claim 17, further comprising:
determining the future time instance associated with one or more of an empty buffer or quality of experience (QoE) degradation based at least in part on a quantity of data in the data buffer and the difference between the first data rate and the second data rate.

19. The method of claim 12, wherein the future time instance is based at least in part on a timer associated with a radio link or beam failure detection.

20. A user equipment (UE) for wireless communications, comprising:
means for receiving configuration information for a radio link, wherein the configuration information enables UE prediction of radio link failure events that will impact a data rate, a spectrum efficiency, or a latency, for communications via the radio link;
means for communicating with a network entity via the radio link;
means for determining, based at least in part on the configuration information, that a predicted data rate, a predicted spectrum efficiency, or a predicted latency, for the communications via the radio link will be below a threshold data rate value, a threshold spectrum efficiency value, or above a threshold latency value, at a future time instance; and
means for transmitting an indication to the network entity that indicates the predicted data rate will be below the threshold data rate value, the predicted spectrum efficiency will be below the threshold spectrum efficiency value, or the predicted latency will be above the threshold latency value, and the future time instance.
